(19) United States
(12) Patent Application Publication
(10) Pub. No.: US 2026/0032503 A1
(43) Pub. Date: Jan. 29, 2026

(54) INTRA-PDU SET QUALITY OF SERVICE ADAPTATION

(71) Applicant: Apple Inc., Cupertino, CA (US)

(72) Inventors: Ping-Heng Kuo, London (GB); Ralf Rossbach, Munich (DE); Fangli Xu, Beijing (CN); Haijing Hu, Los Gatos, CA (US)

(21) Appl. No.: 18/993,037

(22) PCT Filed: Jul. 26, 2022
(86) PCT No.: PCT/CN2022/107951

§ 371 Date: Jan. 10, 2025

(51) Int. Cl. H04W 28/02; H04B 1/40; H04L 5/00

(52) U.S. Cl. CPC H04W 28/0268; H04B 1/40; H04L 5/0048

(57) ABSTRACT

A method of wireless communication by a user equipment (UE) includes receiving a protocol data unit (PDU) set; initiating processing of data packets of the PDU set in accord with a first radio access treatment; determining a set of one or more conditions is met; and switching, in response to the determination, from the processing of data packets of the PDU set in accord with the first radio access treatment to a processing of data packets of the PDU set in accord with a second radio access treatment, the second radio access treatment different from the first radio access treatment.

### TECHNICAL FIELD

This application relates generally to wireless communication systems, including transmissions of protocol data unit (PDU) sets for extended reality (XR) traffic flows.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANS can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In some deployments, the E-UTRAN may also implement NR RAT. In some deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows a couple of PDU sets that may be mapped to quality of service (QoS) or XR traffic flows.

FIG. 2 shows an example method of wireless communication by a UE, which method may be used to make an intra-PDU set QoS adaptation.

FIG. 3 illustrates an example timing of intra-PDU set QoS adaptation.

FIG. 4 shows another example method of wireless communication by a UE, which method may be used to make an intra-PDU set QoS adaptation.

FIGS. 5A-5C illustrate various example subsets of one or more radio link control (RLC) entities, which subsets of RLC entities may be used to facilitate intra-PDU set QoS adaptation.

FIG. 6 shows an example implementation of the method described with reference to FIG. 4.

FIG. 7 illustrates an example architecture of a wireless communication system, according to embodiments described herein.

FIG. 8 illustrates a system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In 3GPP Release 18, 5G NR RAT needs to be enhanced to support special services such as XR services. XR services include, for example, virtual reality (VR), augmented reality (AR), and mixed reality (MR) services. Special services may differ from other services in that they operate on PDU sets, with each PDU set including one or multiple data packets (e.g., internet protocol (IP) packets). Each PDU set may be mapped to the same or different QoS flows, and there can be different numbers of data packets in different PDU sets. A PDU set may also be referred to as an application data unit (ADU).

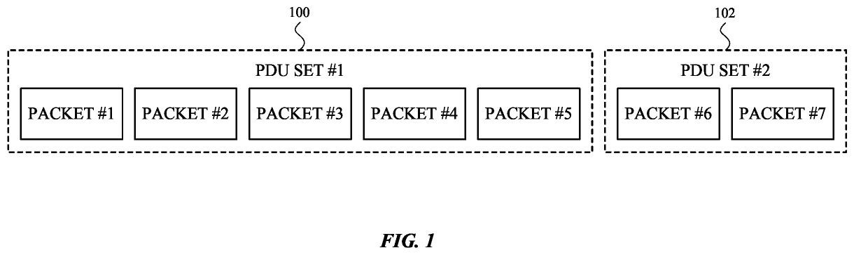

FIG. 1 shows a couple of PDU sets 100, 102 that may be mapped to a QoS flow. By way of example, a first PDU set 100 (PDU Set #1) is shown to include five data packets (PACKETs #1-#5), and a second PDU set 102 (PDU Set #2) is shown to include two data packets (PACKETs #6 and #7). Each PDU set 100, 102 could alternatively have more or fewer data packets, and a QoS flow could alternatively have more or fewer PDU sets.

A user plane function (UPF) may identify a PDU set by means of a PDU set sequence number (SN), an identifier of a starting and/or ending PDU of a PDU set, a PDU SN within a PDU set, and/or a number of PDUs within a PDU set. A QoS flow may be identified by means of a QoS flow identifier (ID). A UPF may further identify information relating to each PDU set, such as a PDU set importance or a PDU set dependency (e.g., an indication of whether use of a PDU set is dependent on a receiver's receipt of another PDU set). A UPF may provide information relating to PDU sets to a RAN.

It has been proposed that new QoS parameters for PDU set-based QoS handling be defined for 5G NR RAT. These new QoS parameters may include, for example, a PDU set delay budget (PSDB); a PDU set error rate (PSER); an indication of whether to drop a PDU set in case its PSDB is exceeded; an indication of whether all data packets in a PDU set need to be received for the PDU set to be used by an application layer; and a PDU set priority.

As a result of the proposed new QoS parameters, a particular subset (or minimum number) of data packets in a PDU set may need to be successfully delivered to a receiver within a PSDB time interval for the PDU set to be useful to an application layer. In some cases, all of the data packets in a PDU set may need to be successfully delivered to a receiver for the PDU set to be useful to an application layer (i.e., no packet loss may be tolerated).

In light of the above observations, it may be useful to make an intra-PDU set QoS adaptation. That is, it may be useful to change the QoS parameters applied to the transmission of a PDU set after transmitting only some, but not all, of the data packets of the PDU set. In this manner, a first QoS may be applied to a first subset of data packets in the PDU set, and a second QoS may be applied to a second subset of data packets in the PDU set. Such a QoS adaptation may strike a balance between special service (e.g., XR service) application performance and radio resource efficiency. For example, when a PSDB is almost expired, a transmitter may transmit the remaining data packets of a PDU set with a higher reliability target or more strict latency requirement, in order to increase the likelihood that all data packets of the PDU set can be successfully delivered within the PSDB. As another example, when a sufficient number of data packets of a PDU set have already been successfully delivered, and there is still plenty of time left within a PSDB, a transmitter may transmit the remaining data packets of the PDU set with a relaxed QoS, in order to save resources (e.g., power and/or radio resources). As another example, when a PSDB is almost expired and a transmitter determines that even a best available QoS will not enable the remaining data packets to be delivered within the PSDB, the transmitter may relax the QoS for the PDU set. In some cases, the QoS parameters applied to a PDU set may be adapted more than once.

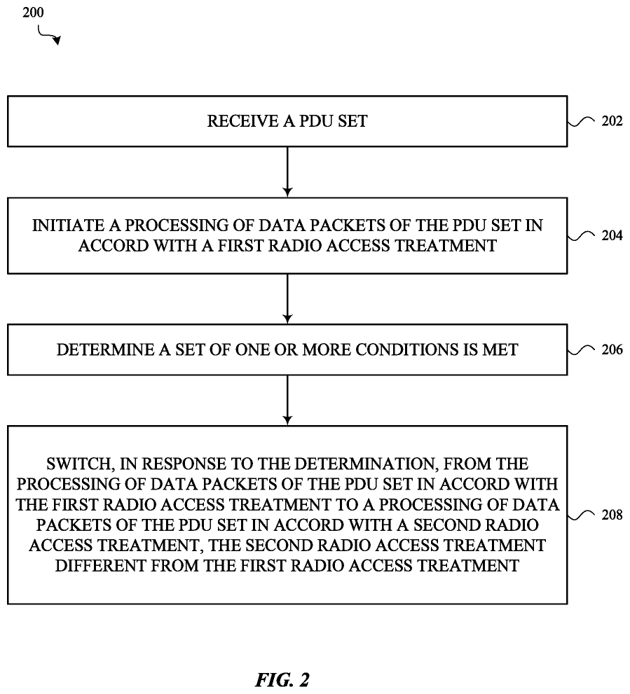

FIG. 2 shows an example method 200 of wireless communication by a UE, which method 200 may be used to make an intra-PDU set QoS adaptation. The method 200 may be performed by a processor of the UE, and transmissions and receptions facilitated by the processor may be made using a transceiver of the UE. Alternatively, the method 200 may be performed by a base station.

At 202, the method 200 may include receiving a PDU set. In some embodiments, the PDU set may be received at a packet data convergence protocol (PDCP) entity. In some embodiments, the PDU set may be associated with an XR traffic flow.

At 204, the method 200 may include initiating a processing of data packets of the PDU set in accord with a first radio access treatment. The first radio access treatment may correspond to a default set of QoS parameters for the PDU set. In some embodiments, the first radio access treatment may be associated with a first set of logical channel parameters (e.g., a first logical channel (LCH) priority, a first prioritized bit rate (PBR), and/or a first LCH mapping restriction).

At 206, the method 200 may include determining a set of one or more conditions is met. In some embodiments, the condition(s) may include expiration of a timer. The timer may be a QoS adaptation (QA) timer that is started contemporaneously with receiving the PDU set (at 202) or beginning to process the data packets of the PDU set to a lower layer (at 204). In some embodiments, the QA timer may be a countdown timer, and the initial value of the QA timer may correspond to a portion of a PSDB for the PDU set. For example, the initial value of the QA timer may be 80% (or some other percentage) of the PSDB for the PDU set.

At 208, the method 200 may include switching, in response to the determination made at 206, from the processing of data packets of the PDU set in accord with the first radio access treatment to a processing of data packets of the PDU set in accord with a second radio access treatment. The second radio access treatment may correspond to an adapted set of QoS parameters for the PDU set, and may be different from the first radio access treatment. In some embodiments, the second radio access treatment may be associated with a second set of LCH parameters (e.g., at least one or all of a second LCH priority, a second PBR, and/or a second LCH mapping restriction). The second LCH priority may differ from the first LCH priority, the second PBR may differ from the first PBR, and the second LCH mapping restriction may differ from the first LCH mapping restriction.

In accord with the method 200, if all of the data packets of the PDU set are processed to a lower layer (or transmitted) before the QA timer expires, intra-PDU set QoS adaptation need not be performed. However, if some or all of the data packets of the PDU set have not been processed to the lower layer (or transmitted) before the QA timer expires, an intra-PDU set QoS adaptation may be made. In some cases, the QoS adaptation may be made to increase the likelihood that all of the data packets of the PDU set will be transmitted or delivered before the PSDB expires. In these cases, the second LCH priority may be a higher LCH priority than the first LCH priority. In other cases, the QoS adaptation may be made to save resources, or to decrease the likelihood that all of the data packets of the PDU set will be transmitted or delivered before the PSDB expires. In these cases, the second LCH priority may be a lower LCH priority than the first LCH priority. In the latter cases, resources may be saved when, for example, when all of the data packets will still be transmitted or delivered within the PSDB, or when it is unlikely that all of the data packets of the PDU set can be transmitted or delivered under any set of QoS parameters.

In some embodiments, the method 200 may include receiving configuration information defining at least part of the set of one or more conditions monitored at 206. The configuration information may be received, for example, from a RAN (e.g., from a base station) or a CN, and may provide a network with flexibility in defining the set of one or more conditions.

In some embodiments, the method 200 may include identifying the set of one or more conditions, monitored at 206, at least partly based on a stored instruction (e.g., a stored instruction based on the implementation of 3GPP specifications).

In some embodiments, the set of one or more conditions monitored at 206 may be at least partly based on a stored instruction, and at least partly defined by configuration information received by the UE.

In some embodiments, the set of conditions monitored at 206 may include one or more other conditions, in addition to or instead of expiration of a timer. For example, the method 200 may include monitoring a delivery of the data packets of the PDU set to a receiver (e.g., monitoring the delivery of the data packets to a base station, via a hybrid automatic repeat request (HARQ) process). In these embodiments, the determination that the set of one or more conditions is met, at 206, may be based at least partly on a predetermined or configured number of data packets of the PDU set having been successfully delivered to the receiver. In some cases, the set of one or more condition(s) may be configured to trigger intra-PDU set QoS adaptation when fewer than the predetermined or configured number of data packets have been successfully delivered to the receiver (e.g., to speed up how fast data packets are transmitted). In these cases, and by way of example, the determination that the set of one or more conditions is met may be based at least partly on whether the number of data packets (of the PDU set) that have been successfully delivered to the receiver has reached a minimum number of successfully delivered data packets of the PDU set (e.g., a minimum number of successfully delivered data packets required by an application layer). When the minimum number has not been reached, an intra-PDU set QoS adaptation may be made to help increase the speed at which data packets are delivered. In some cases, the set of one or more condition(s) may alternatively be configured to trigger intra-PDU set QoS adaptation when more than a predetermined or configured number of data packets have been successfully delivered to the receiver (e.g., to save resources).

In some embodiments in which the method 200 includes monitoring the delivery of the data packets of the PDU set to the receiver, the determination that the set of one or more conditions is met, at 206, may be based at least partly on a predetermined or configured number of data packets of the PDU set having failed delivery to the receiver. In some cases, the set of one or more condition(s) may be configured to trigger intra-PDU set QoS adaptation when more than the predetermined or configured number of data packets have failed delivery to the receiver (e.g., to save resources). In these cases, and by way of example, the determination that the set of one or more conditions is met may be based at least partly on whether the number of data packets (of the PDU set) that have failed delivery to the receiver has reached a maximum number of failed data packets of the PDU set (e.g., a maximum number of failed data packets allowed by an application layer). In some cases, the set of one or more condition(s) may alternatively be configured to trigger intra-PDU set QoS adaptation when fewer than a predetermined or configured number of data packets have failed delivery to the receiver (e.g., to increase the reliability of data packet transmission).

In some embodiments in which the method 200 includes monitoring the delivery of the data packets of the PDU set to the receiver, the determination that the set of one or more conditions is met, at 206, may be based at least partly on whether all essential or critical data packets of the PDU set have been successfully delivered to the receiver. In some cases, the set of one or more condition(s) may be configured to trigger intra-PDU set QoS adaptation when all of the essential or critical packets of the PDU set have already been successfully delivered to the receiver. For example, when all of the essential or critical packets of the PDU set have already been successfully delivered, packet delivery may be slowed to save resources. In some cases, the set of one or more condition(s) may alternatively be configured to trigger intra-PDU set QoS adaptation when all of the essential or critical packets of the PDU set have not been successfully delivered to the receiver. For example, when all of the essential or critical packets of the PDU set have not been successfully delivered, the QoS for the PDU set may be adapted to speed up packet delivery.

In some embodiments, the method 200 may include monitoring how many data packets of the PDU set remain buffered or pending transmission (e.g., monitoring how many data packets remain in a PDCP buffer, one or more RLC buffers, and/or one or more MAC buffers). In these embodiments, the determination that the set of one or more conditions is met, at 206, may be based at least partly on how many data packets of the PDU set remain buffered or pending transmission. In some cases, the set of one or more condition(s) may be configured to trigger intra-PDU set QoS adaptation when more than a predetermined or configured number of data packets remain buffered or pending transmission (e.g., to speed up how fast data packets are transmitted). In some cases, the set of one or more condition(s) may alternatively be configured to trigger intra-PDU set QoS adaptation when fewer than a predetermined or configured number of data packets remain buffered or pending transmission (e.g., to save resources).

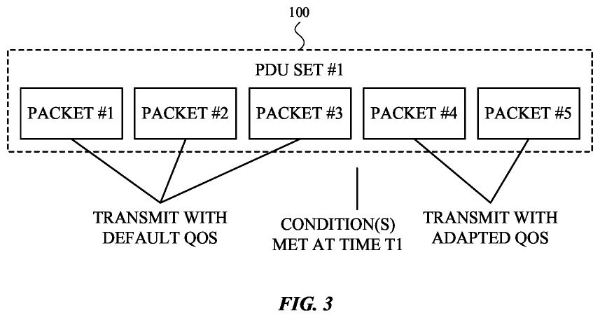

FIG. 3 illustrates an example timing of intra-PDU set QoS adaptation. By way of example, FIG. 3 shows the first PDU set 100 described with reference to FIG. 1. Contemporaneously with receiving the PDU set 100 or beginning to process data packets of the PDU set 100 to a lower layer, a QA timer may be started. While the QA timer is running, data packets #1-#3 may be processed in accord with a first radio access treatment. At time T1, the QA timer may expire. Because data packets of the PDU set 100 remain buffered or pending transmission at time T1, data packets #4 and #5 may be processed in accord with a second radio access treatment. By way of example, the second radio access treatment may speed or slow the transmission of data packets #4 and #5, and/or may increase or decrease the reliability of transmission of data packets #4 and #5.

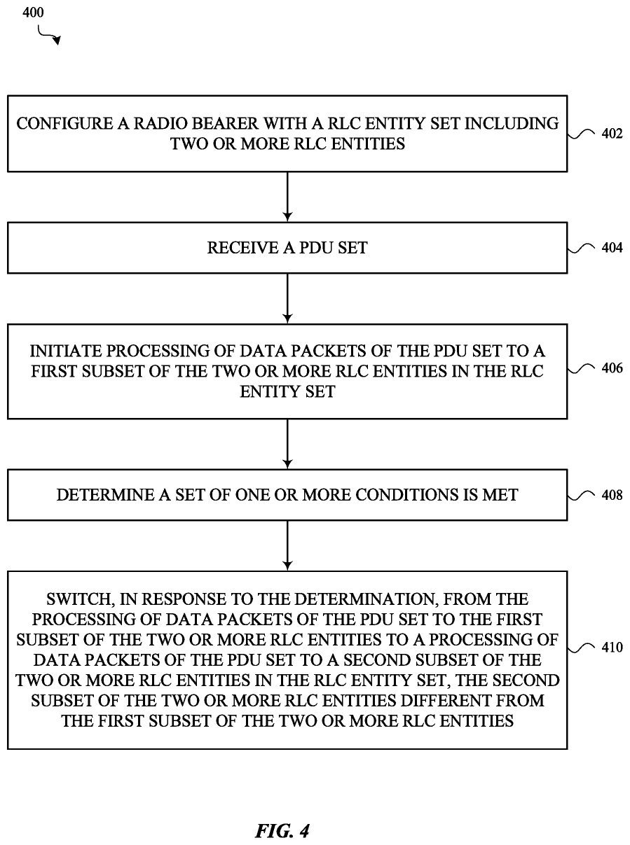

FIG. 4 shows another example method 400 of wireless communication by a UE, which method 400 may be used to make an intra-PDU set QoS adaptation. The method 400 may be performed by a processor of the UE, and transmissions and receptions facilitated by the processor may be made using a transceiver of the UE. Alternatively, the method 400 may be performed by a base station.

At 402, the method 400 may include configuring a radio bearer with a RLC entity set including two or more RLC entities. Each RLC entity may feed packets to a respective medium access control (MAC) entity.

At 404, the method 400 may include receiving a PDU set. In some embodiments, the PDU set may be received at a PDCP entity. In some embodiments, the PDU set may be associated with an XR traffic flow.

At 406, the method 400 may include initiating processing of data packets of the PDU set to a first subset of the two or more RLC entities in the RLC entity set.

At 408, the method 400 may include determining a set of one or more conditions is met. In some embodiments, the condition(s) may include expiration of a timer. The timer may be a QA timer that is started contemporaneously with receiving the PDU set (at 404) or beginning to process the data packets of the PDU set to the first subset of the two or more RLC entities (at 406). In some embodiments, the QA timer may be a countdown timer, and the initial value of the QA timer may correspond to a portion of a PSDB for the PDU set. For example, the initial value of the QA timer may be 80% (or some other percentage) of the PSDB for the PDU set.

At 410, the method 400 may include switching, in response to the determination made at 408, from the processing of data packets of the PDU set to the first subset of the two or more RLC entities to a processing of data packets of the PDU set to a second subset of the two or more RLC entities in the RLC entity set. The second subset of the two or more RLC entities may be different from the first subset of the two or more RLC entities, and may partially or entirely overlap the first subset of the two or more RLC entities.

In some embodiments, the first subset of the two or more RLC entities may apply a first radio access treatment to processed data packets, and the second subset of the two or more RLC entities may apply a second radio access treatment to processed data packets. The first radio access treatment may correspond to a default set of QoS parameters for the PDU set. In some embodiments, the first radio access treatment may be associated with a first LCH having a first parameterization (e.g., a first LCH priority, a first PBR, and a first LCH mapping restriction). The second radio access treatment may correspond to an adapted set of QoS parameters for the PDU set, and may be different from the first radio access treatment. In some embodiments, the second radio access treatment may be associated with a second LCH having a second parameterization (e.g., at least one or all of a second LCH priority, a second PBR, or a second LCH mapping restriction). The second LCH priority may differ from the first LCH priority, the second PBR may differ from the first PBR, and the second LCH mapping restriction may differ from the first LCH mapping restriction. For example, the first LCH mapping restriction may allow the LCH to be mapped to the radio resource of a first configured grant, while the second LCH mapping restriction may allow the LCH to be mapped to the radio resource of a second configured grant, where the targeted reliability may be different between the first configured grant and the second configured grant.

In accord with the method 400, if all of the data packets of the PDU set are processed to the first set of the two or more RLC entities (or transmitted) before the QA timer expires, intra-PDU set QoS adaptation need not be performed. However, if some or all of the data packets of the PDU set have not been processed to the first set of the two or more RLC entities (or transmitted) before the QA timer expires, an intra-PDU set QoS adaptation may be made. In some cases, the QoS adaptation may be made to increase the likelihood that all of the data packets of the PDU set will be transmitted or delivered before the PSDB expires. In other cases, the QoS adaptation may be made to save resources, or to decrease the likelihood that all of the data packets of the PDU set will be transmitted or delivered before the PSDB expires. In the latter cases, resources may be saved when, for example, when all of the data packets will still be transmitted or delivered within the PSDB, or when it is unlikely that all of the data packets of the PDU set can be transmitted or delivered under any set of QoS parameters.

In some embodiments, the method 400 may include receiving configuration information defining at least part of the set of one or more conditions monitored at 408. The configuration information may be received, for example, from a RAN (e.g., from a base station) or a CN, and may provide a network with flexibility in defining the set of one or more conditions.

In some embodiments, the method 400 may include identifying the set of one or more conditions, monitored at 408, at least partly based on a stored instruction (e.g., a stored instruction based on the implementation of 3GPP specifications).

In some embodiments, the set of one or more conditions monitored at 408 may be at least partly based on a stored instruction, and at least partly defined by configuration information received by the UE.

In some embodiments, the set of conditions monitored at 408 may include one or more other conditions, in addition to or instead of expiration of a timer. Examples of other conditions are described with reference to FIG. 2.

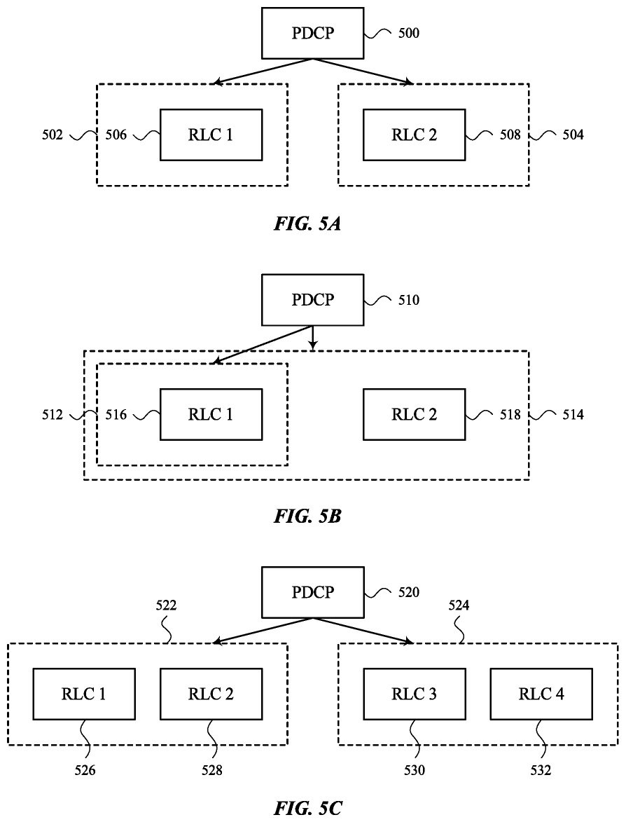

In some embodiments of the method 400, the first subset of the two or more RLC entities may include only a first RLC entity, and the second subset of the two or more RLC entities may include only a second RLC entity (i.e., an RLC entity that is different from the first RLC entity). In other embodiments, the first subset of the two or more RLC entities may include only a first RLC entity, and the second subset of the two or more RLC entities may include the first RLC entity and a second RLC entity. In other embodiments, one or each of the first and second subsets of the two or more RLC entities may include two or more RLC entities. Illustrations of these various configurations are shown in FIGS. 5A-5C.

FIG. 5A shows a first example of a PDCP entity 500 processing data packets of a PDU set to first and second subsets of one or more RLC entities 502, 504, in accord with an intra-PDU set QoS adaptation. In FIG. 5A, the first subset of one or more RLC entities 502 includes only a first RLC entity 506, and the second subset of one or more RLC entities 504 includes only a second RLC entity 508. Prior to a set of conditions being met, and as described for example with reference to any of FIGS. 2-4, the PDCP entity 500 may process data packets of a PDU set to the first RLC entity 506. The first RLC entity 506 may be associated with a first LCH having a first parameterization. If (and after) a set of conditions is met before all of the data packets of the PDU set are processed to the first RLC entity 506, the PDCP entity 500 may process remaining data packets of the PDU set to the second RLC entity 508. The second RLC entity 508 may be associated with a second LCH having a second parameterization.

FIG. 5B shows a second example of a PDCP entity 510 processing data packets of a PDU set to first and second subsets of one or more RLC entities 512, 514, in accord with an intra-PDU set QoS adaptation. In FIG. 5B, the first subset of one or more RLC entities 512 includes only a first RLC entity 516, and the second subset of one or more RLC entities 514 includes the first RLC entity 516 and a second RLC entity 518. Prior to a set of conditions being met, and as described for example with reference to any of FIGS. 2-4, the PDCP entity 510 may process data packets of a PDU set to the first RLC entity 516. The first RLC entity 516 may be associated with a first LCH having a first parameterization. If (and after) a set of conditions is met before all of the data packets of the PDU set are processed to the first RLC entity 516, the PDCP entity 510 may process remaining data packets of the PDU set to both the first RLC entity 516 and the second RLC entity 518. The second RLC entity 518 may be associated with a second LCH having a second parameterization. In some cases, the PDCP entity 510 may process remaining data packets to the first and second RLC entities 516, 518 to achieve packet duplication. In other cases, the PDCP entity 510 may process each remaining data packet to one of the first or second RLC entities 516, 518.

FIG. 5C shows a third example of a PDCP entity 520 processing data packets of a PDU set to first and second subsets of one or more RLC entities 522, 524, in accord with an intra-PDU set QoS adaptation. In FIG. 5C, the first subset of one or more RLC entities includes only a first RLC entity 526 and a second RLC entity 528, and the second subset of one or more RLC entities 524 includes a third RLC entity 530 and a fourth RLC entity 532. Prior to a set of conditions being met, and as described for example with reference to any of FIGS. 2-4, the PDCP entity 520 may process data packets of a PDU set to the first and second RLC entities 526, 528. The first and second RLC entities 526, 528 may be associated with respective LCHs having the same or different parameterization. In some cases, the PDCP entity 520 may process remaining data packets to the first and second RLC entities 526, 528 in a redundant manner. In other cases, the PDCP entity 520 may process each remaining data packet to one of the first or second RLC entities 526, 528. If (and after) a set of conditions is met before all of the data packets of the PDU set are processed to the first and second RLC entities 526, 528, the PDCP entity 520 may process remaining data packets of the PDU set to the third and fourth RLC entities 530, 532. The third and fourth RLC entities 530, 532 may be associated with respective LCHs having the same or different parameterizations. In some cases, the PDCP entity 520 may process remaining data packets to the third and fourth RLC entities 530, 532 in a redundant manner. In other cases, the PDCP entity 520 may process each remaining data packet to one of the third or fourth RLC entities 530, 532.

FIGS. 5A-5C only show example configurations of first and second sets of one or more RLC entities. In other embodiments, each set of one or more RLC entities may include more or fewer overlapping or non-overlapping RLC entities. In some embodiments, more than one QoS adaptation may be performed over the course of processing data packets of a PDU set to different subsets of one or more RLC entities, and there may be a third or additional subset of one or more RLC entities.

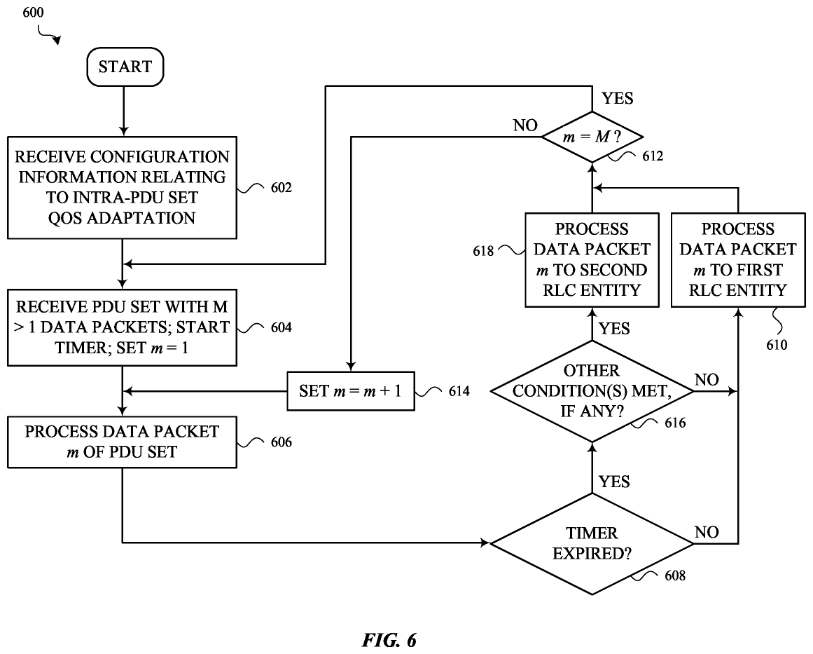

FIG. 6 shows an example implementation 600 of the method described with reference to FIG. 4.

At 602, a UE may optionally receive configuration information relating to intra-PDU set QoS adaptation.

At 604, the UE may receive a PDU set with M>1 data packets. The UE may also start a timer (e.g., a QA timer) and initialize a counter value, m, to m=1.

At 606, the UE may process data packet m of the PDU set.

At 608, the UE may determine whether the timer started at 604 has expired. If it has not expired, the UE may process data packet m to a first set of one or more RLC entities (e.g., to a first RLC entity) at 610.

At 612, the UE may determine whether all data packets of the PDU set have been processed, by determining whether m=M? If all data packets of the PDU set have not been processed, the UE may increment the counter (i.e., set m=m+1) at 614 and return to 606 to process the next data packet of the PDU set. If all data packets of the PDU set have been processed, the UE may return to 604 and receive the next PDU set for processing.

If, at 608, the UE determines that the timer started at 604 has expired and there are more data packets of a PDU set to process, the UE may determine, at 616, whether other conditions, if any, for intra-PDU set QoS adaptation have been met. If so, the UE may process data packet m to a second set of one or more RLC entities (e.g., to a second RLC entity) at 618. Otherwise, if the other conditions, if any, for intra-PDU set QoS adaptation have not been met, the UE may return to 610 and process data packet m to the first set of one or more RLC entities (e.g., to the first RLC entity).

Embodiments contemplated herein include an apparatus having means to perform one or more elements of the method 200, 400, or 600. The apparatus may be, for example, an apparatus of a UE (such as a wireless device 802 that is a UE, as described herein).

Embodiments contemplated herein include one or more non-transitory computer-readable media storing instructions to cause an electronic device, upon execution of the instructions by one or more processors of the electronic device, to perform one or more elements of the method 200, 400, or 600. The non-transitory computer-readable media may be, for example, a memory of a UE (such as a memory 806 of a wireless device 802 that is a UE, as described herein).

Embodiments contemplated herein include an apparatus having logic, modules, or circuitry to perform one or more elements of the method 200, 400, or 600. The apparatus may be, for example, an apparatus of a UE (such as a wireless device 802 that is a UE, as described herein).

Embodiments contemplated herein include an apparatus having one or more processors and one or more computer-readable media, using or storing instructions that, when executed by the one or more processors, cause the one or more processors to perform one or more elements of the method 200, 400, or 600. The apparatus may be, for example, an apparatus of a UE (such as a wireless device 802 that is a UE, as described herein).

Embodiments contemplated herein include a signal as described in or related to one or more elements of the method 200, 400, or 600.

Embodiments contemplated herein include a computer program or computer program product having instructions, wherein execution of the program by a processor causes the processor to carry out one or more elements of the method 200, 400, or 600. The processor may be a processor of a UE (such as a processor(s) 804 of a wireless device 802 that is a UE, as described herein), and the instructions may be, for example, located in the processor and/or on a memory of the UE (such as a memory 806 of the wireless device 802, as described herein).

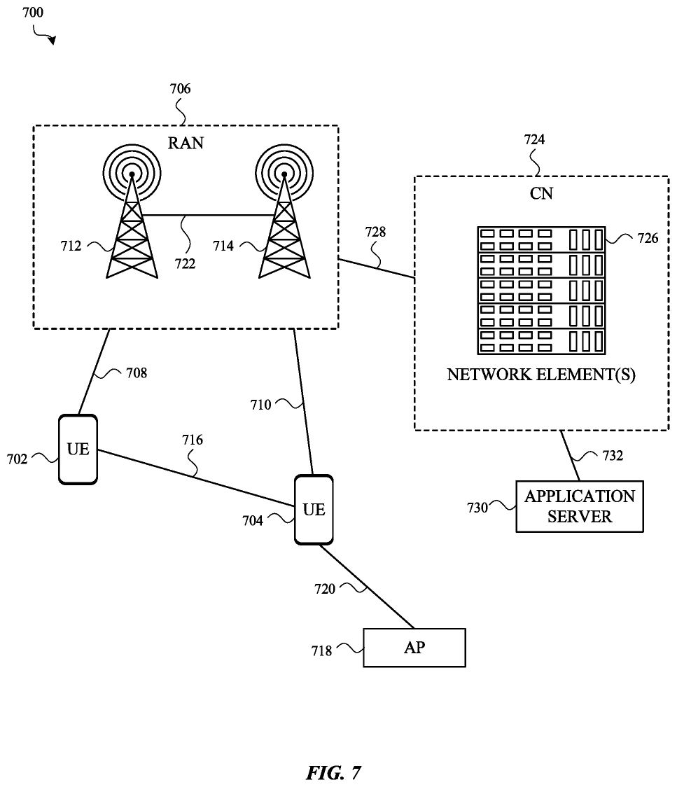

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

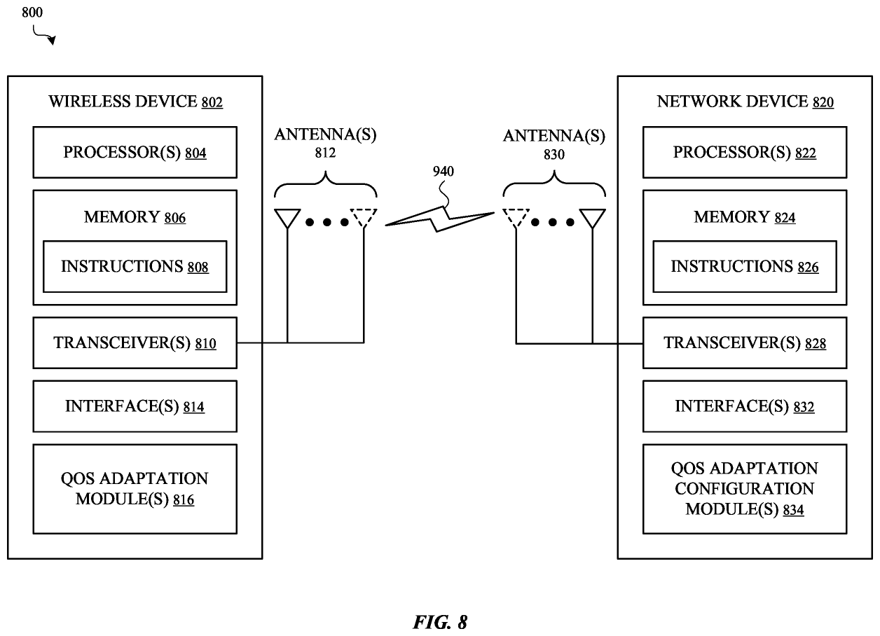

FIG. 8 illustrates a system 800 for performing signaling 840 between a wireless device 802 and a network device 820, according to embodiments disclosed herein. The system 800 may be a portion of a wireless communication system as herein described. The wireless device 802 may be, for example, a UE of a wireless communication system. The network device 820 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 840) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include one or more QoS adaptation module(s) 816. The QoS adaptation module(s) 816 may be implemented via hardware, software, or combinations thereof. For example, the QoS adaptation module(s) 816 may be implemented as a processor, circuit, and/or instructions 808 stored in the memory 806 and executed by the processor(s) 804. In some examples, the QoS adaptation module(s) 816 may be integrated within the processor(s) 804 and/or the transceiver(s) 810. For example, the QoS adaptation module(s) 816 may be implemented by a combination of software components (e.g., executed by a DSP or a general processor) and hardware components (e.g., logic gates and circuitry) within the processor(s) 804 or the transceiver(s) 810.

The QoS adaptation module(s) 816 may be used for various aspects of the present disclosure, for example, aspects of FIGS. 1-6. The QoS adaptation module(s) 816 may be configured to, for example, configure and perform an intra-PDU set QoS adaptation.

The network device 820 may include one or more processor(s) 822. The processor(s) 822 may execute instructions such that various operations of the network device 820 are performed, as described herein. The processor(s) 804 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 840) to and/or from the network device 820 with other devices (e.g., the wireless device 802) according to corresponding RATs.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820 that is a base station may include interface(s) 832 made up of transmitters, receivers, and other circuitry (e.g., other than the transceiver(s) 828/antenna(s) 830 already described) that enables the base station to communicate with other equipment in a core network, and/or that enables the base station to communicate with external networks, computers, databases, and the like for purposes of operations, administration, and maintenance of the base station or other equipment operably connected thereto.

The network device 820 may include one or more QoS adaptation configuration module(s) 834. The QoS adaptation configuration module(s) 834 may be implemented via hardware, software, or combinations thereof. For example, the QoS adaptation configuration module(s) 834 may be implemented as a processor, circuit, and/or instructions 826 stored in the memory 824 and executed by the processor(s) 822. In some examples, the QoS adaptation configuration module(s) 834 may be integrated within the processor(s) 822 and/or the transceiver(s) 828. For example, the QoS adaptation configuration module(s) 834 may be implemented by a combination of software components (e.g., executed by a DSP or a general processor) and hardware components (e.g., logic gates and circuitry) within the processor(s) 822 or the transceiver(s) 828.

The QoS adaptation configuration module(s) 834 may be used for various aspects of the present disclosure, for example, aspects of FIGS. 1-6. The QoS adaptation configuration module(s) 834 may be configured to, for example, configure another device (e.g., the wireless device 802) to perform intra-PDU set QoS adaptation.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
configure a radio bearer with a radio link control (RLC) entity set including two or more RLC entities;
receive a protocol data unit (PDU) set;
initiate processing of data packets of the PDU set to a first subset of the two or more RLC entities in the RLC entity set;
determine a set of one or more conditions is met; and
switch, in response to the determination, from the processing of data packets of the PDU set to the first subset of the two or more RLC entities to processing of data packets of the PDU set to a second subset of the two or more RLC entities in the RLC entity set, the second subset of the two or more RLC entities different from the first subset of the two or more RLC entities.

2. The UE of claim 1, wherein
the RLC entity set includes,
a first RLC entity associated with a first logical channel (LCH), the first LCH having a first set of parameterizations; and
a second RLC entity associated with a second LCH, the second LCH having a second set of parameterizations.

3. The UE of claim 2, wherein:
the first subset of the two or more RLC entities includes the first RLC entity and not the second RLC entity; and
the second subset of the two or more RLC entities includes the second RLC entity and not the first RLC entity.

4. The UE of claim 2, wherein:
the first subset of the two or more RLC entities includes the first RLC entity and not the second RLC entity; and
the second subset of the two or more RLC entities includes the first RLC entity and the second RLC entity.

5. The UE of claim 1, wherein:
the processor is configured to start a timer contemporaneously with receiving the PDU set or beginning to process the data packets of the PDU set to the first subset of the two or more RLC entities; and
the set of one or more conditions includes expiration of the timer.

6. The UE of claim 1, wherein:
the processor is configured to monitor a delivery of the data packets to a receiver; and
the determination that the set of one or more conditions is met is based at least partly on a predetermined or configured number of data packets of the PDU set having been successfully delivered to the receiver.

7. The UE of claim 6, wherein the determination that the set of one or more conditions is met is based at least partly on whether the predetermined or configured number of data packets of the PDU set that have been successfully delivered to the receiver has reached a minimum number of successfully delivered data packets of the PDU set required by an application layer.

8. The UE of claim 1, wherein:
the processor is configured to monitor a delivery of the data packets to a receiver; and
the determination that the set of one or more conditions is met is based at least partly on a predetermined or configured number of data packets of the PDU set having failed delivery to the receiver.

9. The UE of claim 8, wherein the determination that the set of one or more conditions is based at least partly on whether the predetermined or configured number of data packets of the PDU set that have failed delivery to the receiver has reached a maximum number of failed data packets of the PDU set allowed by an application layer.

10. The UE of claim 1, wherein:
the processor is configured to monitor how many data packets of the PDU set remain buffered or pending transmission; and
the determination that the set of one or more conditions is met is based at least partly on how many data packets of the PDU set remain buffered or pending transmission.

11. The UE of claim 1, wherein:
the processor is configured to monitor a delivery of the data packets to a receiver; and
the determination that the set of one or more conditions is met is based at least partly on whether all essential or critical data packets of the PDU set have been successfully delivered to the receiver.

12. The UE of claim 1, wherein:
the processor is configured to,
receive, via the transceiver, configuration information defining at least part of the set of one or more conditions.

13. The UE of claim 1, wherein:
the processor is configured to,
identify the set of one or more conditions at least partly based on a stored instruction.

14. A method of wireless communication by a user equipment (UE), comprising:
receiving a protocol data unit (PDU) set;
initiating a processing of data packets of the PDU set in accord with a first radio access treatment;
determining a set of one or more conditions is met; and
switching, in response to the determination, from the processing of data packets of the PDU set in accord with the first radio access treatment to a processing of data packets of the PDU set in accord with a second radio access treatment, the second radio access treatment different from the first radio access treatment.

15. The method of claim 14, wherein:
the first radio access treatment is associated with a first set of logical channel parameters; and
the second radio access treatment is associated with a second set of logical channel parameters.

16. The method of claim 15, wherein:
the first set of logical channel parameters includes a first logical channel priority;
the second set of logical channel parameters includes a second logical channel priority; and
the second logical channel priority is a higher logical channel priority than the first logical channel priority.

17. The method of claim 15, wherein:
the first set of logical channel parameters includes a first logical channel priority;
the second set of logical channel parameters includes a second logical channel priority; and
the second logical channel priority is a lower logical channel priority than the first logical channel priority.

18. The method of claim 14, further comprising:
starting a timer contemporaneously with receiving the PDU set or beginning to process the data packets of the PDU set to a lower layer; wherein,
the set of one or more conditions includes expiration of the timer.

19. The method of claim 18, wherein an initial value of the timer corresponds to a portion of a PDU set delay budget (PSDB) for the PDU set.

20. The method of claim 14, further comprising:
receiving configuration information defining at least part of the set of one or more conditions.
